(19) United States
(12) Patent Application Publication
(10) Pub. No.: US 2004/0150240 A1
(43) Pub. Date: Aug. 5, 2004

(54) Floor plan for recreational vehicle

(76) Inventor: Doron S. Koren, Jacksonville, FL (US)

Correspondence Address: Doron S. Koren, 2828 Jewell Road, Jacksonville, FL, 32216, US

(21) Appl. No.: 10/358,300

(22) Filed: Feb. 5, 2003

(51) Int. Cl. B60P 3/34

(52) U.S. Cl. 296/26.01

(57) ABSTRACT

Recreational Vehicle (RV) are usually a trailer or a bus size vehicle used for camping or traveling, that is fully self contained, and contains all the amenities like a home, such as kitchen, bedroom, bathroom, shower, and living room etc. However due to DMV restrictions, those vehicles can't be wider than a certain size, usually 8 feet. Another reason for the width limitation is for the safety of the transporter(s) and traffic. If the vehicle is too wide it makes it unsafe and hard to maneuver. That is the reason coach and RV manufacturers try to produce an 8 feet wide RV that expands, so the extra space when parked gives more living area. The invention hereof offers an alternative way to double the available living space by having a floor plan feature counter-double slide out which enable us to provide a more spacious and free flowing transportable dwelling unit, which maximizes the consumers ability to have the extras that the conventional Slide-out arrangement doesn't offer.

### FIELD OF THE INVENTION

The invention relates to a recreational vehicles.

### BACKGROUND OF THE INVENTION

Slide-out rooms are the most popular way to expand coaches and Recreational Vehicles (RV). The most common way of coach expansion is a one side slide out like U.S. Pat. 6,048,016 to Futrell et al. or U.S. Pat. 5,237,782 to Cooper, or U.S. Pat. 5,894,698 to Dewald Jr. et al.

Another popular room expansion is a rear room expansion, like U.S. Pat. 5,628,541 to Gardner. And U.S. Pat. 4,103,462 to Freller.

Another known way to expand the coach is the Pop-up camper arrangement, like U.S. Pat. 5,971,471 to Gardner, which combine a tent on both sides of the coach, and a sideways slide-out.

None of the above inventions can efficiently slide out two opposite direction while increasing the floor space. We define efficiency by not taking the furniture or sacrificing other room space, such as kitchen space etc.

None of the above conventional trailers offers a full trailer size slide-out, rather they offer a partial trailer slide out which usually contains a sofa, dinette, or bed that is stationary in the slide-out.

There are also other known methods of opposite dual slide-outs, like U.S. Pat. 3,815,949 to Ulert. This invention suffers from an inability to use larger king size beds, a full size kitchen, and cabinets mounted to the walls, due to the fact that the walls, the floor, and the ceiling are not flush with each other.

In addition, this arrangement limits the use of wall and ceiling mounted fixtures like ceiling fan and cabinets, etc. Due to this fact, that when folded down, the ceiling and the walls slide on or under each other preventing any fixed mounted appliance or light fixtures on one side of the RV only.

Another drawback of this arrangement is the difficulty in maintaining structural integrity for this kind of mobile vehicle due to the vibration from bad road conditions.

### A BRIEF SUMMARY OF THE INVENTION

The invention hereof offers an alternative way to double the available living space by having a floor plan feature counter-double slide out which enable us to provide a more spacious and free flowing transportable dwelling unit, which maximizes the consumers ability to have the extras that the conventional Slide-out arrangement doesn't offer.

Said counter-double slide out contain a king size bed which pivoted to an axis allows it go up when the Slideout room are retracted into the trailer.

In addition this invention offers a full size bathroom that counter slide to the bed room, and a full size walk in closet which slide into the trailer and the counter slideout space.

Another unique feature of this new invention is the resilience of the structural integrity of a full trailer size slide-out that's subjected to massive vibrations of bad road conditions.

### LIST OF THE DRAWINGS

FIG. 1, shows the brief perspective view of the RV;

FIG. 2, shows the partial front view of the RV, in the parking state, when the slideout are slide from the chassis and the bed is turn down;

FIG. 3, shows the partial front view of the RV, when the two slideout are retracted into the chassis and the bed is turn up;

FIG. 4, shows the full floor-plan view of the RV when the RV is parked and expands its living space to maximum.

FIG. 5, shows the floor-plan view of the RV, when the RV is at movement position and the two slideout are retracted into the chassis.

### A DETAIL DESCRIPTION OF THE INVENTION

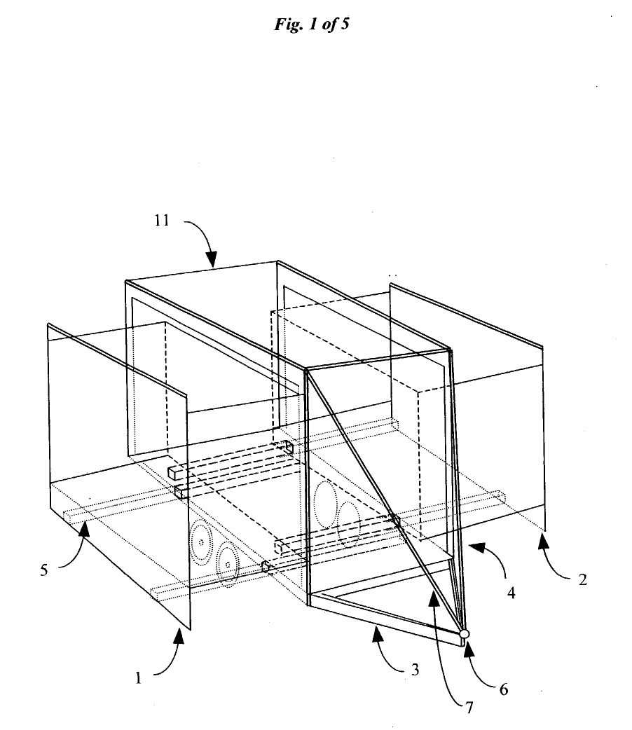

FIG. 1.

The invention hereof FIG. 1 consist of a trailer chassis (11), two counter movement slide out (1) and (2). The Slideout (1) and (2) are supported by the slideout rail 5.

Said chassis (11) supported by two diagonal members (7) and (4). The diagonal member contribute to the structural integrity of the trailer while subjected to vibration due to bad road conditions.

Said member are connected to the main towing beam (3). The trailer is towed via the hitch (6).

When the RV is in movement, the two Slideout are retracted into the chassis, when parked the Slideout are slide out of the chassis thus creating a double living space.

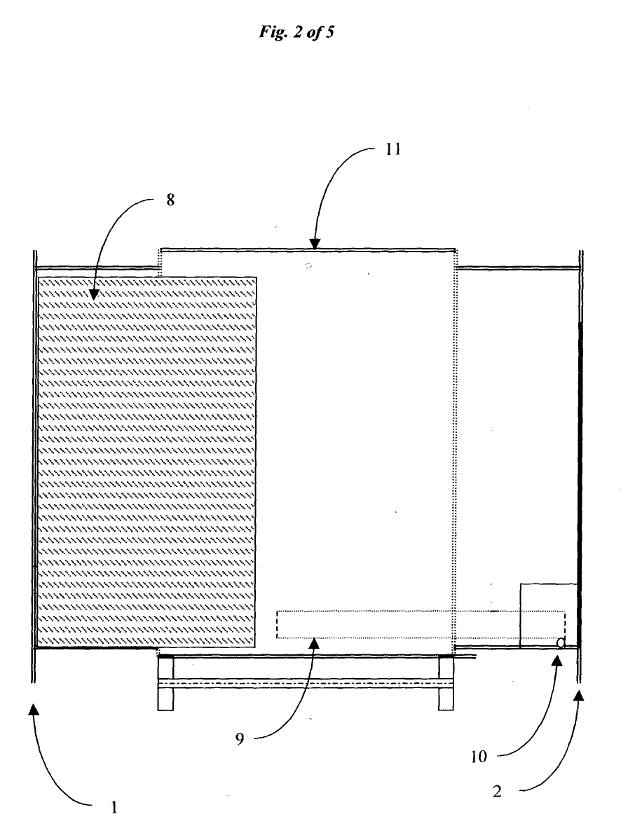

FIG. 2.

The invention hereof FIG. 2 is a partial front view of the RV, consist of a trailer chassis (11), two counter movement slide out (1) and (2).

The right Slideout (2) contain the bedroom. The bed (9) are connected to the slideout room via pivot (10) allowing the bed to move up when the Slideout are retracted inside the chassis. Said mechanism allows to design a full size bathroom (8) in the counter slideout room (1). The pivot (10) can be mounted on the slideout as shown in FIG. 2, or can be mounted on the chassis,

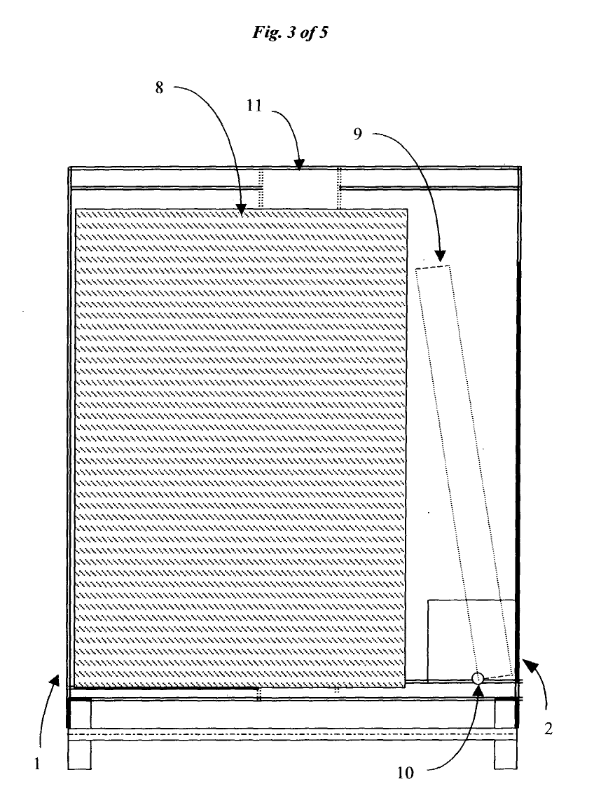

FIG. 3.

FIG. 3 shows a partial front view of the RV when the two slideout (1) and (2) are retracted into the chassis (11).

The bed (9) is connected to the slideout room via pivot (10) moved to the upper position, using a motor, a hand movement or the slideout movement itself.

This arrangement allows to design a room wider then the slideout itself, and still retract both of the slideout (1) and (2) to the chassis (11).

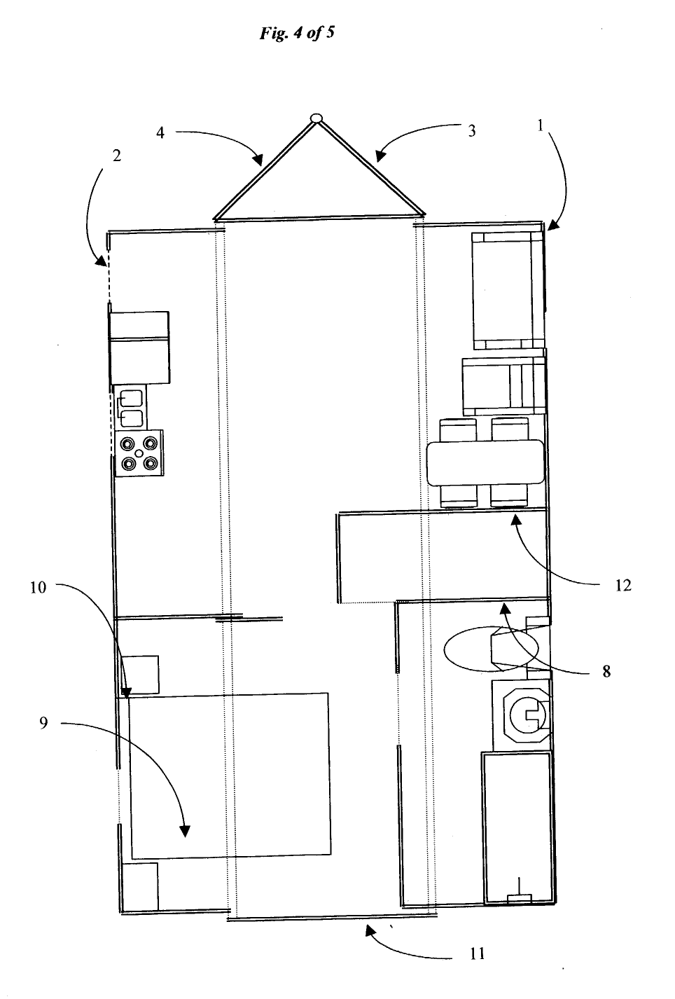

FIG. 4.

FIG. 4 shows the full floor-plan view of the RV when the RV is parked and expands its living space to maximum.

FIG. 4 shows the trailer chassis (11), two counter movement slide out (1) and (2), both of them are full-trailer-size slideout. The left Slideout (2) contain the kitchen, and the bedroom all off them are fixed mounted to the slideout (2).

The right slideout (1) contain the living room, a dinette, a walk-in closet room (12) wider then the slideout (1), and a full size bathroom (8), all off them are fixed mounted to the slideout (1).

When the slideout expand, the bed (9) are turned down, around pivot (10).

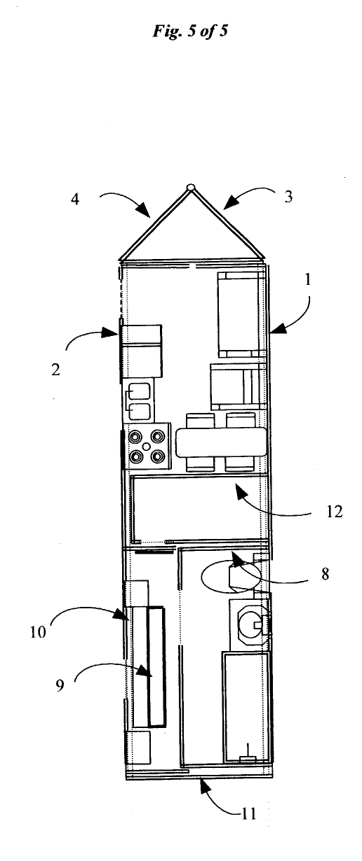

FIG. 5.

FIG. 5 shows the floor-plan view of the RV, when the RV is at movement position and the two full-trailer-size slideout (1) and (2) are retracted into the chassis.

FIG. 5 shows the trailer chassis (11), two-counter movement slide out (1) and (2) retracted into the chassis. The left Slideout (2) contain the kitchen, and the bedroom all off them are fixed mounted to the slideout (2).

The right slideout (1) contain the living room, a dinette, a walk-in closet room (12) wider then the slideout (1) and retracted all the way into the counter slideout space (2), the full size bathroom (8) retracted all the way into the counter slideout space (2). The bed (9) are turned up, around pivot (10) allows the bathroom mounted on the counter slideout (1) to be retracted into the space of slideout (2).

I claim:

1) A recreational vehicle, motorized or un-motorized, contain a chassis, at least one counter movement slideout, a bed connected via pivot to the slideout or to the chassis, said bed are turn up when the slideout is retracted and turn down when the slideout slide of the RV out.

2) A recreational vehicle, motorized or un-motorized, contain a chassis, at least one counter movement slideout according to claim 1, in which the chassis is reinforced by at least one diagonal member from the upper part of the chassis to the lower part of the chassis.

3) A recreational vehicle, motorized or un-motorized, contain a chassis, at least one counter movement slideout according to claim 1, in which the chassis is reinforced by at least one diagonal member connecting the hitch to the upper side of the chassis.

4) A recreational vehicle, motorized or un-motorized, according to claim 1, contain at least one bed which lift up by a motor or by hand, or by the slideout movement itself. Said bed movement is coordinate with the slideout retraction movement.

5) A recreational vehicle, motorized or un-motorized, according to claim 1, contain two counter movement slideout, said slideout containing a room larger then the slideout which can retract into the space of the counter slideout.

6) A recreational vehicle, motorized or un-motorized, according to claim 1, at least one counter movement slideout, said slideout contain a room that can be larger or smaller then the slideout which can retract into the counter slideout space
